(19) United States
(12) Patent Application Publication
(10) Pub. No.: US 2026/0220826 A1
(43) Pub. Date: Jul. 30, 2026

(54) SYNTHETIC DATA GENERATION, AUGMENTATION, AND MODIFICATION USING DIFFUSION FOR ROBOTICS SYSTEMS AND APPLICATIONS

(71) Applicant: NVIDIA Corporation, Santa Clara, CA (US)

(72) Inventors: Wei LIU, Santa Clara, CA (US); Huihua Zhao, San Jose, CA (US)

(21) Appl. No.: 19/036,439

(22) Filed: Jan. 24, 2025

(51) Int. Cl. G06T 11/00; G06T 7/90; G06T 9/00

(52) U.S. Cl. CPC G06T 11/00; G06T 7/90; G06T 9/00

(57) ABSTRACT

In various examples, systems and methods for synthetic data generation, augmentation, and modification using diffusion based techniques are provided. One or more diffusion models (e.g., latent diffusion models) may be used to generate synthetic data (e.g., images) based on semantic image(s) and/or textual information. The diffusion model(s) may be trained using datasets that include corresponding ground truth images, semantic images, and textual information. Semantic image embedding(s) may be generated by encoding received semantic image(s), and text embedding(s) may be generated by encoding received textual information. The semantic image embedding(s) may be concatenated with noise to generate concatenated embedding(s). Image(s) may be generated from noise or the concatenated embedding(s) using the diffusion model(s). A denoising network of the diffusion model(s) may be conditioned using the text embedding(s) through one or more cross-attention mechanisms.

### BACKGROUND

Warehouses present a distinct and challenging environment for the development of autonomous navigation systems. For example, warehouses often embody a semi-structured layout, blending areas of unstructured open space that may have a variety of obstacles (e.g., shelving units, boxes, pallets, workers, other machinery, etc.) with structured pathways where mobile robots (e.g., autonomous mobile robots (AMRs), forklifts, humanoid robots, etc.) are expected to adhere to predefined traffic rules. Due to the frequent movement of some obstacles (e.g., workers and other vehicles or machines) in these environments, the pathways for autonomous machines to navigate may be unpredictable such that an autonomous machine may be required to continuously adapt and make real-time decisions to avoid collisions. To accommodate these challenges and others (e.g., varying lighting conditions), advanced sensors and algorithms may be needed for the autonomous machines to accurately perceive and interpret the surroundings as well as navigate in the environment. Further, autonomous machines often require precise and efficient movement to ensure timely operations, which may add another layer of complexity to the development and deployment of autonomous vehicles.

### SUMMARY

Embodiments of the present disclosure relate to synthetic data generation, augmentation, and modification using diffusion for robotics systems and applications. Systems and methods are disclosed that may be used for, among other things, generating synthetic images that may be used to train one or more models for a variety of tasks (e.g., autonomous machine navigation models).

In contrast to conventional systems, the systems and methods presented in this disclosure may use one or more diffusion models (e.g., latent diffusion models) to generate synthetic data (e.g., RGB images, CMYK images, monochrome images, IR images, etc.) based on semantic images and/or textual information. The diffusion model(s) may be trained using datasets that include corresponding ground truth images (e.g., RGB images, CMYK images, monochrome images, IR images, etc.), semantic images, and textual information. The diffusion model(s) for the present disclosure may generate an image from a semantic image (image-to-image generation), from textual information (text-to-image generation), and/or from a semantic image and textual information (image/text-to-image generation). By using semantic images and textual information to train the diffusion model(s), there may be better control over the synthetic data generated using the trained diffusion model(s), which may lead to faster production of high-quality training data for a variety of tasks.

### BRIEF DESCRIPTION OF THE DRAWINGS

The present systems and methods for synthetic data generation, augmentation, and modification using diffusion for robotics systems and applications are described in detail below with reference to the attached drawing figures, wherein:

FIG. 1 is an illustration of an example data flow diagram for a synthetic data generation operating environment suitable for use in implementing some embodiments of the present disclosure;

FIG. 2 is an illustration of an example data flow diagram for a synthetic data generation operating environment suitable for use in implementing some embodiments of the present disclosure;

FIG. 3 is an illustration of an example data flow diagram for a synthetic data generation operating environment suitable for use in implementing some embodiments of the present disclosure;

FIG. 4 is an illustration of an example semantic image generator/editor suitable for use in implementing some embodiments of the present disclosure;

FIG. 5 includes an example semantic image, in accordance with some embodiments of the present disclosure;

FIG. 6 includes an example synthetic image generated using a synthetic data generation system based on the semantic image of FIG. 5, in accordance with some embodiments of the present disclosure;

FIG. 7 is an illustration of an example flow diagram for synthetic data generation, in accordance with some embodiments of the present disclosure;

FIG. 8 is an illustration of an example flow diagram for synthetic data generation, in accordance with some embodiments of the present disclosure;

FIG. 9 is a block diagram of an example computing device suitable for use in implementing some embodiments of the present disclosure; and

FIG. 10 is a block diagram of an example data center suitable for use in implementing some embodiments of the present disclosure.

### DETAILED DESCRIPTION

Systems and methods are disclosed related to synthetic data generation, augmentation, and modification using diffusion for robotics systems and applications. Although the present disclosure may be described with respect to an example autonomous or semi-autonomous vehicle or machine, this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, watercraft, shuttles (e.g., robotaxis), emergency response vehicles, motorcycles, electric or motorized bicycles, aircraft, construction vehicles, underwater craft (e.g., piloted or unpiloted submarines), drones, and/or other vehicle or machine types. In addition, although the present disclosure may be described with respect to synthetic data generation for robotics applications, this is not intended to be limiting, and the systems and methods described herein may be used in augmented reality (AR), virtual reality (VR), mixed reality (MR), robotics, security and surveillance (e.g., smart cities), autonomous or semi-autonomous machine applications, industrial manufacturing, and/or any other technology spaces where synthetic data generation may be used.

Given the complexity of environments such as warehouses, buildings, parking garages, and/or other dynamic and dense spaces, navigating autonomous systems using traditional rule-based or classical navigation systems may struggle to adapt and scale efficiently, and autonomous navigation systems may be unable to effectively operate without frequent fine tuning when the environment changes. An alternative that appears promising for addressing the challenges with traditional rule-based or classical navigation systems may include machine learning based approaches. These learning based approaches may include an end-to-end learning approach where the autonomous navigation systems predict actions directly from raw observations (e.g., using a deep neural network (DNN)). The learning based approaches may also include a modular learning approach where the autonomous navigation system explores with a learned policy based on semantic mapping. Recent advancements in robotics foundational models have made learning based approaches more feasible, but these models are often hindered by the limited availability and/or sparse nature of training data. Adequate training data is critical for training models (e.g., for autonomous navigation applications) that are capable of generalizing across varied scenarios (e.g., in a warehouse).

Augmenting limited training data may help improve model accuracy, reduce overfitting, correct imbalanced datasets, and/or improve generalization of the models. Training data images may be augmented by modifying one or more properties (e.g., contrast, brightness, noise, etc.) of the training data images. Additional training data may also be generated by generating and augmenting synthetic data. Typically, synthetic data is generated using randomization of environment settings (e.g., lighting conditions) and/or asset settings (textures, patterns, etc.) for a simulation of a scene, and the synthetic data may be further augmented by introducing distortions to alter the synthetic data after generation. However, these techniques may be inefficient because the settings are typically manually changed between simulations. Further, if characteristics of an asset/object in the scene are to be changed, then this may require updating or adding information to a Universal Scene Description (USD) file for the asset/object, which may be time consuming and inefficient.

Techniques have been proposed for using generative models for synthetic data generation to address some of the issues with the more manual process of changing the environment settings and/or asset settings for simulations of scenes. Current techniques for text-to-image generative models may allow for virtually unlimited amounts of synthetic data to be produced using text prompts to query the models. While in-context data augmentations and self-supervised representation learning methods are being developed, it may still be difficult to control the output image generated using current text-to-image diffusion models that rely on text prompts (e.g., Stable Diffusion). For example, these text-to-image diffusion models may generate a completely different image when the user slightly adjusts the text prompt. Inpainting may be used to remove unwanted elements from the generated image or to add elements to the generated image, but it may still be difficult to control the specific modifications of the generated images. These techniques fall short for developing a robust set of training data sufficient for training navigation models for warehouse environments and other challenging navigation environments.

In contrast to conventional systems, such as those described above, the systems and methods presented in this disclosure may use one or more diffusion models (e.g., latent diffusion models) to generate synthetic data (e.g., red, green, blue (RGB) images, cyan, magenta, yellow, key (CMYK) images, monochrome images, infrared (IR) images, etc.) based on semantic images and/or textual information (e.g., text prompt(s)). The diffusion model(s) for the present disclosure may generate image(s) from semantic image(s) (image-to-image generation), from textual information (text-to-image generation), or from semantic image(s) and textual information (image/text-to-image generation) in combination. The diffusion model(s) may be trained using datasets that include corresponding images (e.g., RGB images, CMYK images, monochrome images, IR images, etc.), semantic images, and textual information. By using semantic images and textual information to train the diffusion model(s), the techniques described herein provide large scale synthetic data generation with sufficient control over characteristics of the generated images to produce training data for navigation models that may enable autonomous navigation in warehouse environments or other challenging navigation environments.

The diffusion model(s) used for generating synthetic data images may be trained using a training dataset that includes synthetic training data (e.g., RGB images, semantic images, and textual information). In some embodiments, the training dataset may also include real-world data. The synthetic training data of the training dataset may be generated by randomizing properties of the scene and/or assets as discussed above, and each combination of randomized properties (layout, texture, lighting, etc.) may be accompanied by textual annotations. The RGB images may include photorealistic images of a scene, the semantic images may include pixel-wise semantic label images (e.g., each semantic class/type may be represented by a unique RGB color), and the textual information may include text outlining the scene's randomized properties.

The semantic images may depict components of the scene for the image (e.g., floor, exterior walls, ceiling, etc.) using one or more first colors that correspond to particular semantic types. The semantic images may also depict one or more objects in the scene using colors that are different than those used to depict the components of the scene. The semantic images may depict one or more stationary objects (e.g., shelves, boxes, pallets, etc.) using one or more second colors that correspond to particular semantic types and that are different than the one or more first colors. The semantic images may also depict one or more dynamic objects (e.g., forklifts, humans, robots, etc.) using one or more third colors that correspond to particular semantic types and that are different than the one or more first colors and the one or more second colors.

The semantic images may be taken from samples of an existing dataset (including corresponding RGB images and textual information) or the semantic images may be generated using other techniques. The semantic images may be generated from corresponding RGB images using one or more machine learning models. For example, the semantic images may be generated using semantic segmentation models. Other techniques may also be used for generating the semantic images for the corresponding RGB images.

The textual information (e.g., text prompts) for the corresponding RGB images may be manually generated. In some embodiments, the textual information for the corresponding RGB images may be generated using one or more machine learning models. For example, the textual information may be generated using one or more vision language models (e.g., NVIDIA VILA, OpenAI GPT-4o, etc.), multi-modal language models, etc. Other techniques may also be used for generating the textual information for the corresponding RGB images.

For each round of training the diffusion model(s), a ground truth (e.g., RGB) image may be provided to an encoder (e.g., a variational autoencoder (VAE) encoder), which may generate a latent space representation of the ground truth image, and a forward diffusion process of the diffusion model(s) may iteratively add Gaussian noise to the latent space representation of the ground truth image to generate a noise embedding. For conditioning, a semantic image corresponding to the ground truth image may be provided to another encoder (e.g., a VAE encoder), which may generate a semantic image embedding (e.g., a tensor), and textual information corresponding to the ground truth image may be provided to another encoder (e.g., a CLIP encoder), which may generate a text embedding. The semantic image embedding may be concatenated with the noise embedding to generate a concatenated embedding (e.g., a tensor). A denoising network (e.g., U-Net based model) of the diffusion model(s) may be trained to iteratively remove noise from the concatenated embedding based on conditioning using the text embedding through one or more cross-attention mechanisms to generate a latent space representation of an image. The latent space representation of the image may be decoded (e.g., using a VAE decoder) to generate an (e.g., RGB) image. Ideally, the image generated by the decoder would be the same as the input ground truth image. During the training process, a loss between the noise predicted by the denoising network and the noise applied to the latent space representation of the ground truth image in the forward diffusion process may be determined and used to fine tune the operation of the denoising network. After sufficient training, the loss between the noise predicted by the denoising network and the noise applied to the latent space representation of the ground truth image in the forward diffusion process will converge, and the diffusion model(s) may be used to transform semantic images and/or textual information into images depicting highly detailed, realistic scenes.

In some embodiments, the diffusion model(s) may receive only a semantic image as conditioning for generating a particular image during inference. The semantic image may be provided by user input and/or may be generated using one or more machine learning models (e.g., semantic segmentation models). The semantic image may be compressed or encoded (e.g., using a VAE encoder) to generate a semantic image embedding. The semantic image embedding may be concatenated with noise (e.g., random noise) to generate a concatenated embedding. An image may be generated from the concatenated embedding using the diffusion model(s). For example, the denoising network of the diffusion model(s) may iteratively remove noise from the concatenated embedding to generate a latent space representation, and the latent space representation may be decoded (e.g., using a VAE decoder) to generate the image.

In some embodiments, the diffusion model(s) may receive only textual information as conditioning for generating a particular image during inference. The textual information may be provided by user input and/or may be generated using one or more machine learning models (e.g., large language models, vision-language models, etc.). The textual information may be encoded (e.g., using a CLIP encoder) to generate a text embedding. An image may be generated from noise (e.g., random noise) using the diffusion model(s) based at least on the text embedding. For example, the denoising network of the diffusion model(s) may iteratively remove noise from the noise based on conditioning using the text embedding through one or more cross-attention mechanisms to generate a latent space representation, and the latent space representation may be decoded (e.g., using a VAE decoder) to generate the image.

In some embodiments, the diffusion model(s) may receive both a semantic image and textual information as conditioning for generating a particular image during inference. The semantic image and/or the textual information may be provided by user input and/or generated using one or more machine learning models. The semantic image may be compressed or encoded to generate a semantic image embedding, and the semantic image embedding may be concatenated with noise to generate a concatenated embedding. The textual information may be encoded to generate a text embedding. An image may be generated from the concatenated embedding using the diffusion model(s) based at least on the text embedding. For example, the denoising network of the diffusion model(s) may iteratively remove noise from the concatenated embedding based on conditioning using the text embedding through one or more cross-attention mechanisms to generate a latent space representation. The latent space representation may be decoded to generate the image.

In some embodiments, the semantic images provided as input for inference may be generated using a semantic image generator/editor. The semantic image generator/editor may comprise one or more tools that enable generating/editing semantic images. The semantic image generator/editor may include sketching tools, one or more libraries of components of a scene or objects for particular types of applications that may be added to a semantic image, or other tools that enable adding components of a scene or objects to a semantic image. The semantic image generator/editor may also include editing tools that enable components of the scene or objects to be modified (e.g., adjust the size, location, orientation, etc.) or removed from the semantic image. The semantic image generator/editor may use one or more machine learning models to generate/edit semantic images based on textual information. The semantic image generator/editor may use one or more machine learning models to generate semantic images based on input images (e.g., RGB images) using semantic segmentation. The semantic image generator/editor may enable a user to conduct exploratory “what if” analysis by facilitating intuitive generation and/or modification of semantic images to augment synthetic datasets.

Additional synthetic data may be generated based on the images that are output by the diffusion model(s). In some embodiments, one or more of the images output by the diffusion model(s) may be used to produce a new semantic image (e.g., using one or more semantic segmentation models). The new semantic image by be provided as input to the diffusion model(s) with textual information (e.g., text prompt(s)) to produce modifications to the output image in a controlled manner. The new semantic image may also modified using the semantic image generator/editor described herein. For example, the semantic image generator/editor may be used to add, modify, or remove one or more structural components and/or one or more objects for the new semantic image in order to modify the image in a controlled manner.

In some embodiments, the diffusion model(s) may be used for video generation (e.g., on a frame-by-frame basis). For example, semantic images and/or textual information may be provided to the diffusion model(s) for each frame, and the diffusion model(s) may output corresponding images for each frame. The images corresponding to the frames may be generated in sequential order and then converted to sequential frames of a video using video editing software, one or more machine learning models, or the like.

Embodiments presented in the disclosure primarily refer to generation of RGB images using the diffusion model(s). However, it should be understood that techniques similar to those described herein may also be used to generate other types of images (e.g., CMYK images, monochrome images, IR images, etc.). Embodiments presented in this disclosure may be implemented in the context of generating, augmenting, or modifying synthetic data. The synthetic data may be used in training navigation systems such as, but not limited to, autonomous vehicles, semi-autonomous vehicles, piloted and un-piloted robots or robotic platforms, warehouse vehicles, off-road vehicles, vehicles coupled to one or more trailers, aircraft, spacecraft, boats, shuttles, emergency response vehicles, construction vehicles, underwater craft, drones, and/or other vehicle types and operating in a variety of locations, such as, but not limited to, warehouses, factories, retail stores, and/or other locations. It should be understood that techniques similar to those described herein may be implemented for generating, augmenting, or modifying synthetic data for use in training for other types of applications as well.

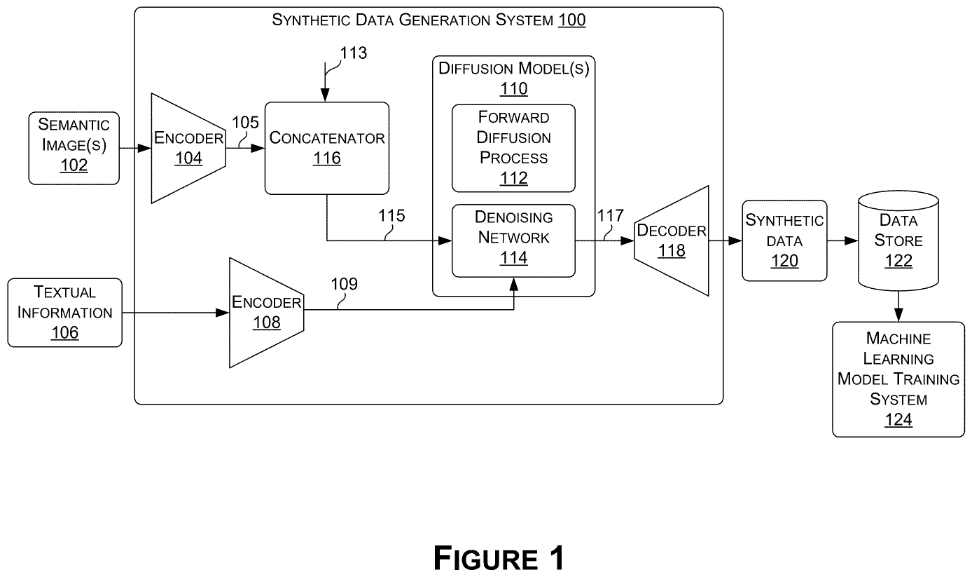

With reference to FIG. 1, FIG. 1 is an example data flow diagram illustrating the interconnection of components and flow of information or data for a synthetic data generation system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown in FIG. 1, the synthetic data generation system 100 may generate synthetic data 120 from semantic image(s) 102 and textual information 106 using one or more diffusion models 110. The synthetic data 120 generated using the diffusion model(s) 110 may be stored in a data store 122 for subsequent use by another process. For example, the synthetic data 120 may be retrieved from the data store 122 by a machine learning model training system 124, which may be used for training one or more models for a variety of different applications (autonomous vehicle navigation, etc.). The synthetic data 120 may be retrieved from the data store 122 for use in generating additional synthetic images or semantic images.

Although examples may be described herein with respect to using machine learning models, such as neural networks or diffusion models, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., autoencoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, state space models (SSMs) (e.g., networks using Mamba architectures (e.g., Mamba-1, Mamba 2, etc.), networks using selective state space models, networks using structured state space sequence models, etc.), diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), large action models (LAMs), etc.), and/or other types of machine learning models.

In the example shown in FIG. 1, the synthetic data generation system 100 may receive semantic image(s) 102 as input. The semantic image(s) 102 may comprise pixel-wise semantic label images (e.g., each semantic class/type represented by a unique RGB color). The semantic image(s) 102 may depict one or more objects in the scene using colors that are different than those used to depict the components of the scene. The semantic image(s) 102 may depict one or more stationary objects (e.g., shelves, boxes, pallets, etc.) using one or more second colors that correspond to particular semantic types and that are different than the one or more first colors. The semantic image(s) 102 may also depict one or more dynamic objects (e.g., forklifts, humans, robots, etc.) using one or more third colors that correspond to particular semantic types and that are different than the one or more first colors and the one or more second colors. The semantic image(s) 102 may be taken from samples of an existing dataset or may be generated using other techniques (e.g., using a semantic image generator/editor). The semantic image(s) 102 may be generated from corresponding image(s) (e.g., RGB image(s)) using one or more machine learning models (e.g., semantic segmentation models). Other techniques may also be used for generating the semantic image(s) 102.

The synthetic data generation system 100 may include an encoder 104. The encoder 104 may compress or encode the semantic image(s) 102 to generate semantic image embedding(s) 105. The semantic image embedding(s) 105 may comprise a latent space representation of the semantic image(s) 102. The encoder 104 may comprise a variational autoencoder (VAE) encoder or other type of encoder suitable for generating the semantic image embedding(s) 105 based on the semantic image(s) 102 received as input.

In the example shown in FIG. 1, the synthetic data generation system 100 may also receive textual information 106. The textual information 106 may comprise textual description of desired features of the synthetic data 120 to be generated using the synthetic data generation system 100. The textual information 106 may be provided by a user (e.g., via a user interface). The textual information 106 may also be generated by one or more machine learning models (e.g., vision-language models).

The synthetic data generation system 100 may include an encoder 108. The encoder 108 may encode the textual information 106 to generate the text embedding(s) 109. The text embedding(s) 109 may comprise a latent space representation of the textual information 106. The encoder 108 may comprise a Contrastive Language-Image Pre-Training (CLIP) encoder or other type of encoder suitable for generating the text embedding(s) 109 based on the textual information 106 received as input.

While the synthetic data generation system 100 shown in FIG. 1 includes encoder 104 and encoder 108 for encoding the semantic image(s) 102 and the textual information 106, respectively, it should be understood that other configurations of the synthetic data generation system 100 are also possible. For example, the synthetic data generation system 100 may be configured to receive the semantic image embedding(s) 105 and/or the text embedding(s) 109 as inputs where a user or system encodes the semantic image(s) 102 and/or textual information 106 separate from the synthetic data generation system 100. In such examples, the encoder 104 and/or the encoder 108 may be omitted from the synthetic data generation system 100.

In the example shown in FIG. 1, the semantic image embedding(s) 105 may be output by the encoder 104 and provided to a concatenator 116. The concatenator 116 may also receive noise 113 as input. The noise 113 may comprise, for example, random noise, white noise, or another type of noise (e.g., generated by a noise generator). The concatenator 116 may concatenate the semantic image embedding(s) 105 with the noise 113 to generate a concatenated embedding 115. The concatenated embedding 115 may comprise a high-dimensionality vector (e.g., tensor) that captures a representation of the semantic image embedding(s) 105 and the noise 113. The concatenated embedding(s) 115 may be provided as an input (e.g., conditioning) for the diffusion model(s) 110.

The synthetic data generation system 100 includes one or more diffusion models 110. The diffusion model(s) 110 may comprise one or more latent diffusion models. Each of the diffusion model(s) 110 includes a forward diffusion process 112 and denoising network 114. The forward diffusion process 112 may be used primarily during training, which is discussed in more detail below. The denoising network 114 may comprise a U-Net based model (e.g., or other convolutional neural network (CNN) for image generation) or other type denoising network. The denoising network 114 may iteratively remove noise from the concatenated embedding 115 based on conditioning using the text embedding 109 through one or more cross-attention mechanisms to generate a latent space representation of synthetic data 117. The latent space representation of the synthetic data 117 may be a latent space representation of an image (e.g., RGB image) or other type of synthetic data to be generated using the synthetic data generation system 100.

The latent space representation of the synthetic data 117 may be provided to a decoder 118. The decoder 118 may comprise a VAE decoder or other type of decoder. The decoder 118 may decode the latent space representation of the synthetic data 117 to generate synthetic data 120. The synthetic data 120 may comprise image(s) or another type of synthetic data. For example, the synthetic data 120 may include RGB images, CMYK images, monochrome images, IR images, or other types of images. In some embodiments, the synthetic data 120 may include ground-truth data corresponding to the image(s). The synthetic data 120 may comprise highly detailed, realistic scenes that may be used for training one or more machine learning models (e.g., using machine learning model training system 124). The synthetic data 120 may be stored (e.g., to a data store 122) and/or used, for example, for training one or more autonomous navigation models (e.g., using machine learning model training system 124) or other purposes. For example, one or more parameters of one or more neural networks may be updated based on the synthetic data 120 (e.g., image(s) and ground-truth data corresponding to the image(s)).

While the synthetic data generation system 100 shown in FIG. 1 includes the decoder 118 for decoding the latent space representation of the synthetic data 117, it should be understood that other configurations of the synthetic data generation system 100 are also possible. For example, the synthetic data generation system 100 may be configured to output the latent space representation of the synthetic data 117 where a user or system decodes the latent space representation of the synthetic data 117 separate from the synthetic data generation system 100. In such examples, the decoder 118 may be omitted from the synthetic data generation system 100.

In some embodiments, the diffusion model(s) 110 may be trained using one or more datasets that include corresponding ground truth images, semantic images, and textual information. The ground truth images used for training the diffusion model(s) 110 may include photorealistic images of a scene (e.g., RGB images) or other types of images (e.g., CMYK images, monochrome images, IR images, etc.). The ground truth images may be synthetically generated, for example, by randomizing properties of the scene and/or assets, and each combination of randomized properties (layout, texture, lighting, etc.) may be accompanied by textual annotations. The ground truth images may also include real-world data captured using one or more sensors (e.g., RGB sensor(s), IR sensor(s), RGB-IR sensor(s), depth sensor(s), camera(s), or other types of sensor(s)).

The semantic images corresponding to the ground truth images may include pixel-wise semantic label images (e.g., each semantic class/type represented by a unique RGB color). The semantic images corresponding to the ground truth images in the training dataset may depict components of the scene for the images (e.g., floor, exterior walls, ceiling, etc.) using one or more first colors that correspond to particular semantic types. The semantic images may also depict one or more objects in the scene using colors that are different than those used to depict the components of the scene. The semantic images may depict one or more stationary objects (e.g., shelves, boxes, pallets, etc.) using one or more second colors that correspond to particular semantic types and that are different than the one or more first colors. The semantic images may also depict one or more dynamic objects (e.g., forklifts, humans, robots, etc.) using one or more third colors that correspond to particular semantic types and that are different than the one or more first colors and the one or more second colors. The semantic images may be taken from samples of an existing dataset (including corresponding ground truth images and textual information) or the semantic images may be generated using other techniques. The semantic images may be generated from corresponding images using one or more machine learning models. For example, the semantic images may be generated using semantic segmentation models. Other techniques may also be used for generating the semantic images for the corresponding images.

The textual information may include text outlining the scene's randomized properties. The textual information (e.g., text prompts) corresponding to the ground truth images in the training dataset may be manually generated. In some embodiments, the textual information may be generated using one or more machine learning models. For example, the textual information may be generated using one or more vision-language models (e.g., NVIDIA VILA, OpenAI GPT-4o, etc.), multi-modal language models, etc. Other techniques may also be used for generating the textual information for the corresponding images.

For each round of training the diffusion model(s) 110, a ground truth image may be provided to an encoder (e.g., a VAE encoder), which is not shown in FIG. 1. The encoder may generate a latent space representation of the ground truth image, and the forward diffusion process 112 of the diffusion model(s) 110 may iteratively add Gaussian noise to the latent space representation of the ground truth image to generate a noise embedding. For conditioning, a semantic image corresponding to the ground truth image may be provided to the encoder 104, which may generate a semantic image embedding (e.g., a tensor), and the semantic image embedding may be concatenated with noise embedding (e.g., using the concatenator 116) to generate a concatenated embedding. Textual information corresponding to the ground truth image may be provided to the encoder 108, which may generate a text embedding.

The concatenated embedding and the text embedding may be provided to the denoising network 114. The denoising network 114 may iteratively remove noise from the concatenated embedding based on conditioning using the text embedding through one or more cross-attention mechanisms to generate a latent space representation of synthetic data. The latent space representation of synthetic data may be a latent space representation of an image (e.g., RGB image) or other type of synthetic data to be output by the synthetic data generation system 100. Ideally, the image output by the synthetic data generation system 100 during training would be the same as the input ground truth image.

During the training process, a loss between the noise predicted by the denoising network 114 and the noise applied to the latent space representation of the ground truth image using the forward diffusion process 112 may be determined and used to fine tune the operation of the denoising network 114. After sufficient training, the loss between the noise predicted by the denoising network 114 and the noise applied to the latent space representation of the ground truth image in the forward diffusion process 112 will converge, and the diffusion model(s) 110 may be used for inference (as discussed above with respect to FIG. 1) to generate synthetic data 120 from semantic image(s) 102 and textual information 106 as described herein.

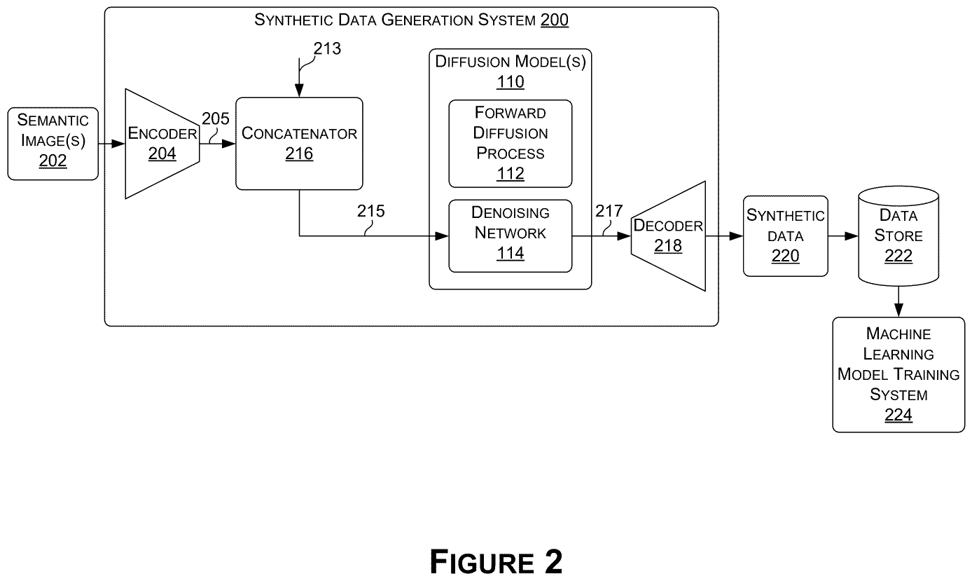

With reference to FIG. 2, FIG. 2 is an example data flow diagram illustrating the interconnection of components and flow of information or data for a synthetic data generation system 200, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown in FIG. 2, the synthetic data generation system 200 may generate synthetic data 220 during inference from semantic image(s) 202 without textual information using the diffusion model(s) 110. The synthetic data 220 generated using the diffusion model(s) 110 may be stored in a data store 222 for subsequent use by another process. For example, the synthetic data 220 may be retrieved from the data store 222 by a machine learning model training system 224, which may be used for training one or more models for a variety of different applications (autonomous vehicle navigation, etc.). The synthetic data 220 may be retrieved from the data store 222 for use in generating additional synthetic images or semantic images.

In the example shown in FIG. 2, the synthetic data generation system 200 may receive semantic image(s) 202 as input without receiving any textual information (as discussed above with respect to FIG. 1). The semantic image(s) 202 may comprise pixel-wise semantic label images (e.g., each semantic class/type represented by a unique RGB color). The semantic image(s) 202 may depict one or more objects in the scene using colors that are different than those used to depict the components of the scene. The semantic image(s) 202 may depict one or more stationary objects (e.g., shelves, boxes, pallets, etc.) using one or more second colors that correspond to particular semantic types and that are different than the one or more first colors. The semantic image(s) 202 may also depict one or more dynamic objects (e.g., forklifts, humans, robots, etc.) using one or more third colors that correspond to particular semantic types and that are different than the one or more first colors and the one or more second colors. The semantic image(s) 202 may be taken from samples of an existing dataset or may be generated using other techniques (e.g., using a semantic image generator/editor). The semantic image(s) 202 may be generated from corresponding image(s) (e.g., RGB image(s)) using one or more machine learning models (e.g., semantic segmentation models). Other techniques may also be used for generating the semantic image(s) 202.

The synthetic data generation system 200 may include an encoder 204. The encoder 204 may compress or encode the semantic image(s) 202 to generate semantic image embedding(s) 205. The semantic image embedding(s) 205 may comprise a latent space representation of the semantic image(s) 202. The encoder 204 may comprise a variational autoencoder (VAE) or other type of encoder suitable for generating the semantic image embedding(s) 205 based on the semantic image(s) 202 received as input.

While the synthetic data generation system 200 shown in FIG. 2 includes encoder 204 for encoding the semantic image(s) 202, it should be understood that other configurations of the synthetic data generation system 200 are also possible. For example, the synthetic data generation system 200 may be configured to receive the semantic image embedding(s) 205 as input where a user or system encodes the semantic image(s) 202 separate from the synthetic data generation system 200. In such examples, the encoder 204 may be omitted from the synthetic data generation system 200.

In the example shown in FIG. 2, the semantic image embedding(s) 205 may be output by the encoder 204 and provided to a concatenator 216. The concatenator 216 may also receive noise 213 as input. The noise 213 may comprise, for example, random noise, white noise, or another type of noise (e.g., generated by a noise generator). The concatenator 216 may concatenate the semantic image embedding(s) 205 with the noise 213 to generate a concatenated embedding 215. The concatenated embedding 215 may comprise a high-dimensionality vector (e.g., tensor) that captures a representation of the semantic image embedding(s) 205 and the noise 213. The concatenated embedding(s) 215 may be provided as an input (e.g., conditioning) for the diffusion model(s) 110.

The synthetic data generation system 200 includes the diffusion model(s) 110, which may comprise the same model(s) described above with respect to FIG. 1. The denoising network 114 of the diffusion model(s) 110 in the synthetic data generation system 200 may iteratively remove noise from the concatenated embedding 215 to generate a latent space representation of synthetic data 217 without using conditioning based on text embeddings through one or more cross-attention mechanisms. The latent space representation of the synthetic data 217 may be a latent space representation of an image (e.g., RGB image) or other type of synthetic data to be generated using the synthetic data generation system 200.

The latent space representation of the synthetic data 217 may be provided to a decoder 218. The decoder 218 may comprise a VAE decoder or other type of decoder. The decoder 218 may decode the latent space representation of the synthetic data 217 to generate synthetic data 220. The synthetic data 220 may comprise image(s) or another type of synthetic data. For example, the synthetic data 220 may include RGB images, CMYK images, monochrome images, IR images, or other types of images. In some embodiments, the synthetic data 220 may include ground-truth data corresponding to the image(s). The synthetic data 220 may comprise highly detailed, realistic scenes that may be used for training one or more machine learning models (e.g., using machine learning model training system 224). The synthetic data 220 may be stored (e.g., to a data store 222) and/or used, for example, for training one or more autonomous navigation models (e.g., using machine learning model training system 224) or other purposes. For example, one or more parameters of one or more neural networks may be updated based on the synthetic data 220 (e.g., image(s) and ground-truth data corresponding to the image(s)).

While the synthetic data generation system 200 shown in FIG. 2 includes the decoder 218 for decoding the latent space representation of the synthetic data 217, it should be understood that other configurations of the synthetic data generation system 200 are also possible. For example, the synthetic data generation system 200 may be configured to output the latent space representation of the synthetic data 217 where a user or system decodes the latent space representation of the synthetic data 217 separate from the synthetic data generation system 200. In such examples, the decoder 218 may be omitted from the synthetic data generation system 200.

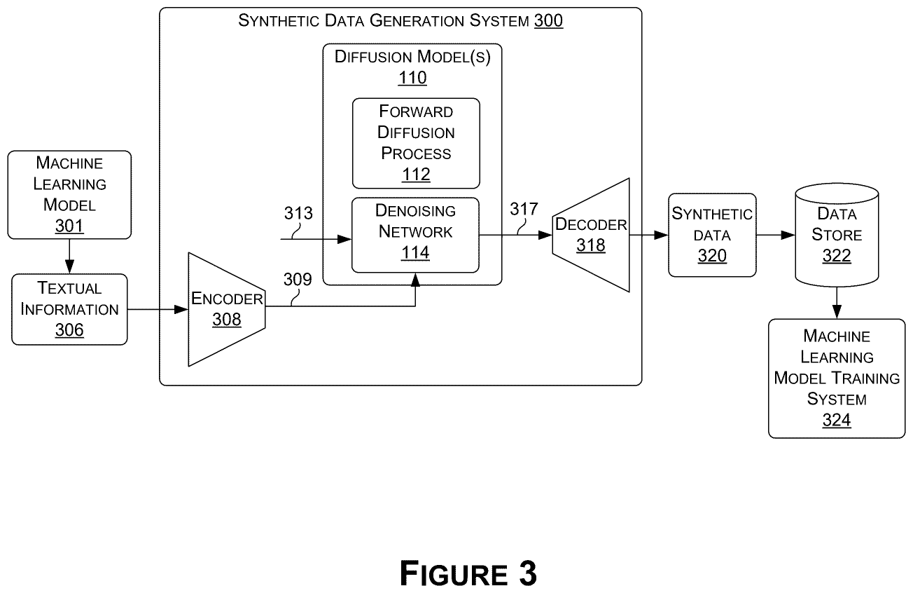

With reference to FIG. 3, FIG. 3 is an example data flow diagram illustrating the interconnection of components and flow of information or data for a synthetic data generation system 300, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

As shown in FIG. 3, the process may include a synthetic data generation system 300 that generates synthetic data 320 during inference from textual information 306 without semantic image(s) using one or more diffusion models 110. The synthetic data 320 generated using the diffusion model(s) 110 may be stored in a data store 322 for subsequent use by another process. For example, the synthetic data 320 may be retrieved from the data store 322 by a machine learning model training system 324, which may be used for training one or more models for a variety of different applications (autonomous vehicle navigation, etc.). The synthetic data 320 may be retrieved from the data store 322 for use in generating additional synthetic images or semantic images.

In the example shown in FIG. 3, the synthetic data generation system 300 may receive textual information 306. The textual information 306 may comprise textual description (e.g., text prompt(s)) of desired features of the synthetic data 320 to be generated using the synthetic data generation system 300. The textual information 306 may be provided by a user via one or more user interfaces (e.g., I/O component(s) 914 of computing device(s) 900). The textual information 306 may also be generated by one or more machine learning models (e.g., vision-language models).

The synthetic data generation system 300 may include an encoder 308. The encoder 308 may encode the textual information 306 to generate the text embedding(s) 309. The text embedding(s) 309 may comprise a latent space representation of the textual information 306. The encoder 308 may comprise a Contrastive Language-Image Pre-Training (CLIP) encoder or other type of encoder suitable for generating the text embedding(s) 309 based on the textual information 306 received as input.

While the synthetic data generation system 300 shown in FIG. 3 includes the encoder 308 for encoding the textual information 306, it should be understood that other configurations of the synthetic data generation system 300 are also possible. For example, the synthetic data generation system 300 may be configured to receive the text embedding(s) 309 as input where a user or system encodes the textual information 306 separate from the synthetic data generation system 300. In such examples, the encoder 308 may be omitted from the synthetic data generation system 300.

The synthetic data generation system 300 includes the diffusion model(s) 110, which may comprise the same model(s) described above with respect to FIG. 1. In the example shown in FIG. 3, the denoising network 114 may receive noise 313 as input rather than a concatenated embedding (as described above with respect to FIGS. 1-2). The noise 313 may comprise, for example, random noise, white noise, or another type of noise (e.g., generated by a noise generator). The denoising network 114 of the diffusion model(s) 100 in the synthetic data generation system 300 may iteratively remove noise from the noise 313 based on conditioning using the text embedding 309 through one or more cross-attention mechanisms to generate a latent space representation of synthetic data 317. The latent space representation of the synthetic data 317 may be a latent space representation of an image (e.g., RGB image) or other type of synthetic data to be generated using the synthetic data generation system 300.

The latent space representation of the synthetic data 317 may be provided to a decoder 318. The decoder 318 may comprise a VAE decoder or other type of decoder. The decoder 318 may decode the latent space representation of the synthetic data 317 to generate synthetic data 320. The synthetic data 320 may comprise image(s) or another type of synthetic data. For example, the synthetic data 320 may include RGB images, CMYK images, monochrome images, IR images, or other types of images. The synthetic data 320 may comprise image(s) or another type of synthetic data. The synthetic data 320 may comprise highly detailed, realistic scenes that may be used for training one or more machine learning models (e.g., using machine learning model training system 324). The synthetic data 320 may be stored (e.g., to a data store 322) and/or used, for example, for training one or more autonomous navigation models (e.g., using machine learning model training system 324) or other purposes. For example, one or more parameters of one or more neural networks may be updated based on the synthetic data 320 (e.g., image(s) and ground-truth data corresponding to the image(s)).

While the synthetic data generation system 300 shown in FIG. 3 includes the decoder 318 for decoding the latent space representation of the synthetic data 317, it should be understood that other configurations of the synthetic data generation system 300 are also possible. For example, the synthetic data generation system 300 may be configured to output the latent space representation of the synthetic data 317 where a user or system decodes the latent space representation of the synthetic data 317 separate from the synthetic data generation system 300. In such examples, the decoder 318 may be omitted from the synthetic data generation system 300.

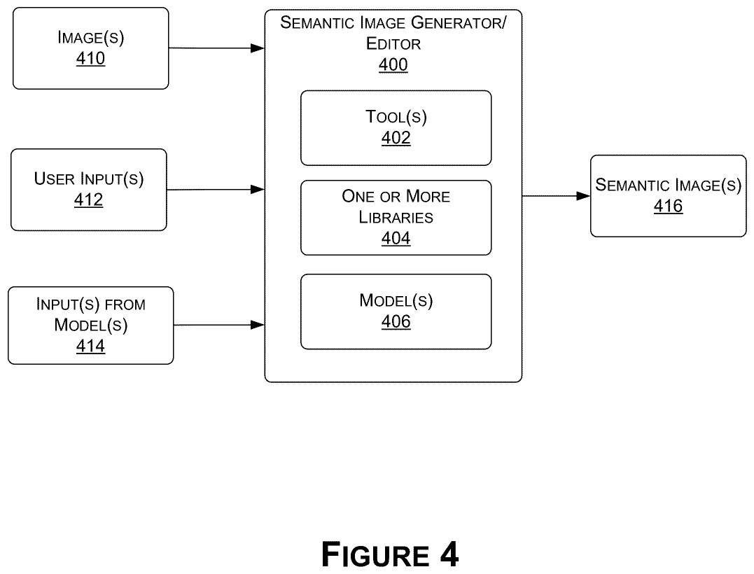

Now referring to FIG. 4, FIG. 4 is a block diagram of an example semantic image generator/editor 400, in accordance with some embodiments of the present disclosure. As shown in FIG. 4, the semantic image generator/editor 400 may include one or more tools 402, one or more libraries 404, and one or more models 406. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The semantic image generator/editor 400 may receive a variety of inputs for generating and/or editing semantic image(s) including, but not limited to, image(s) 410, user input(s) 412, and/or textual information 414. The image(s) 410 may include semantic image(s), RGB image(s), CMYK images, monochrome images, IR images, or other types of images. The user input(s) 412 may include commands, clicks, and/or other user input provided via one or more user interface components (e.g., I/O component(s) 914 of computing device(s) 900). The textual information 414 may include text prompt(s) generated by a user and/or one or more machine learning models. The semantic image generator/editor 400 may generate and output semantic image(s) 416 based on the image(s) 410, the user input(s) 412, and/or the textual information 414. The semantic image generator/editor 400 may edit semantic image(s) input based on the image(s) 410, the user input(s) 412, and/or the textual information 414 and output edited semantic image(s) 416. The semantic image(s) 416 output by the semantic image generator/editor 400 may be stored (e.g., in a data store) and input to a synthetic data generation system (e.g., synthetic data generation system 100, 200).

The tool(s) 402 of the semantic image generator/editor 400 may include one or more tools that enable components of the scene or objects to be added to a semantic image prior to being output by the semantic image generator/editor 400. For example, sketching, drawing, and/or painting tools may be used to sketch, draw, or paint desired components of the scene or objects within the scene depicted in the semantic image. A user may sketch, draw, or paint components of a scene (e.g., floor, walls, ceiling, etc.) and/or objects within the scene having different semantic types using different respective colors assigned to those semantic types.

The one or more libraries 404 of the semantic image generator/editor 400 may include one or more shape libraries that include various shapes. The one or more libraries 404 may include a basic shapes library that may include a rectangle, triangle, circle, or other various shapes commonly used in image generation or editing. The one or more libraries 404 may also include shape libraries that may be more specifically tailored to particular use cases. For example, where the semantic image generator/editor 400 may be used to generate or edit semantic image(s) related to a warehouse, the one or more libraries 404 may include a shape library with a forklift, shelves, boxes, pallets, and other features that may commonly be found in a warehouse setting. The tool(s) 402 may include an insert tool that enables a user to add one or more shapes from the one or more libraries 404 to the semantic image.

The tool(s) 402 of the semantic image generator/editor 400 may include editing tool(s) that enable components of the scene or objects to be modified within the semantic image or removed from the semantic image. For example, a sketch or shape that has been added to the semantic image (e.g., from the one or more libraries 404) may be selected and the properties of the sketch or shape (e.g., size, location, orientation, etc.) may be adjusted using the editing tool(s).

The model(s) 406 of the semantic image generator/editor 400 may include machine learning model(s) that may perform a variety of tasks. For example, the model(s) 406 may include semantic segmentation model(s) that generate a semantic image from a different type of image input to the semantic image generator/editor 400 (e.g., an RGB image). The model(s) 406 also may include editing model(s) that modify a semantic image based on textual information 414 provided to the semantic image generator/editor 400.

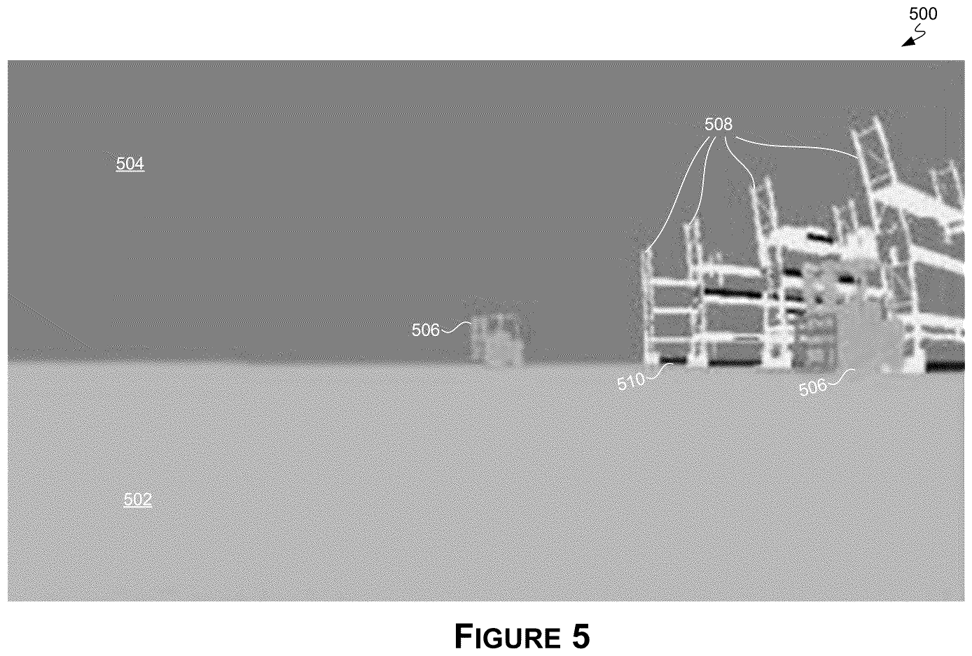

Now referring to FIG. 5, FIG. 5 is an example semantic image 500, in accordance with some embodiments of the present disclosure. The semantic image 500 may be provided to a synthetic data generation system (e.g., synthetic data generation system 100, 200) in order to generate synthetic data. The semantic image 500 may be generated using a semantic image generator/editor (e.g., semantic image generator/editor 400). In the example shown in FIG. 5, the semantic image 500 depicts components of a scene for a warehouse having two different semantic types. For example, the semantic image 500 includes a first semantic type shown at 502, which corresponds to a floor of the warehouse, and a second semantic type shown at 504, which corresponds to the walls/ceiling of the warehouse. The semantic image 500 also depicts dynamic objects in the warehouse. For example, the semantic image 500 includes two instances of a third semantic type shown at 506, which correspond to forklifts in the warehouse. The semantic image 500 also depicts stationary objects in the warehouse. For example, the semantic image 500 includes multiple instances of a fourth semantic type shown at 508, which correspond to shelves of the warehouse, and multiple instances of a fifth semantic type shown at 510, which correspond to boxes or pallets stored on the shelves of the warehouse.

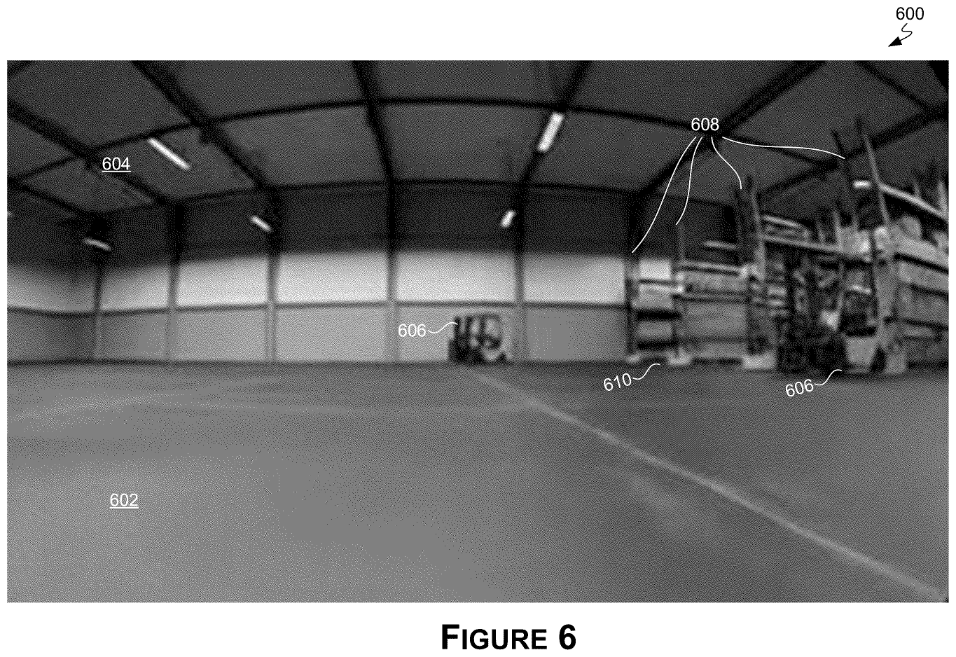

Now referring to FIG. 6, FIG. 6 is an example synthetic image 600, in accordance with some embodiments of the present disclosure. The synthetic image 600 may be generated using a synthetic data generation system (e.g., synthetic data generation system 100, 200) based at least on the semantic image 500 shown in FIG. 5. In the example shown in FIG. 6, the synthetic image 600 depicts components of a scene for a warehouse corresponding to the different semantic types from the semantic image 500. For example, the synthetic image 600 depicts the floor 602 and the walls/ceiling 604 of the warehouse where the corresponding first and second semantic types were included in the semantic image 500. The synthetic image 600 also depicts forklifts 606 where the third semantic type was included in the semantic image 500. The semantic image 500 also depicts shelves 608 of the warehouse and boxes/pallets 610 on the shelves where the corresponding fourth and fifth semantic types were included in the semantic image 500.

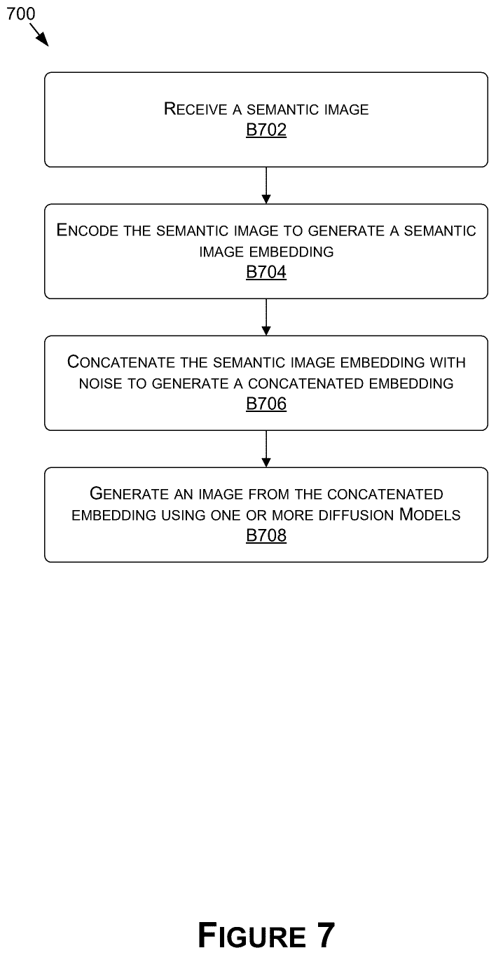

Now referring to FIG. 7, FIG. 7 is a flow diagram showing a method 700 for generating synthetic images, in accordance with some embodiments of the present disclosure. Each block of method 700, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 700 is described, by way of example, with respect to the systems of FIGS. 1-2. However, this method may additionally or alternatively be executed by any one system, or any combination of systems, including, but not limited to, those described herein.

The method 700, at block B702, includes receiving a semantic image. The semantic image may be provided by a user (e.g., via a user interface). The semantic image may be provided by system component (e.g., model or semantic image generator/editor 400). The semantic image may comprise pixel-wise semantic label images (e.g., each semantic class/type represented by a unique RGB color). The semantic image may depict components of the scene and/or objects in the scene using colors that correspond to particular semantic types. For example, as described with respect to FIGS. 1-2, a semantic image may depict one or more objects in the scene using colors that are different than those used to depict the components of the scene. The semantic image may depict one or more stationary objects (e.g., shelves, boxes, pallets, etc.) using one or more second colors that correspond to particular semantic types and that are different than the one or more first colors. The semantic image may also depict one or more dynamic objects (e.g., forklifts, humans, robots, etc.) using one or more third colors that correspond to particular semantic types and that are different than the one or more first colors and the one or more second colors. The semantic image may be taken from samples of an existing dataset or may be generated using other techniques (e.g., using a semantic image generator/editor). The semantic image may be generated from a corresponding image (e.g., RGB image) using one or more machine learning models (e.g., semantic segmentation models). Other techniques may also be used for generating the semantic image.

The method 700, at block B704, includes encoding the semantic image to generate a semantic image embedding. The received semantic image may be compressed or encoded to generate a semantic image embedding (e.g., semantic image embedding(s) 105, 205). For example, as discussed above with respect to FIGS. 1-2, the received semantic image may be provided to an encoder (e.g., encoder 104, 204) and compressed or encoded using the encoder to generate the semantic image embedding. The semantic image embedding may comprise a latent space representation of the received semantic image that is generated by the encoder. For example, the semantic image embedding may comprise one or more vectors, a tensor, or another type of latent space representation of the received semantic image that is generated by the encoder. The encoder may comprise a variational autoencoder (VAE) or other type of encoder suitable for generating a semantic image embedding based on a semantic image received as input.

The method 700, at block B706, includes concatenating the semantic image embedding with noise to generate a concatenated embedding. The semantic image embedding and noise may be concatenated to generate a concatenated embedding using a component of a synthetic data generation system. For example, as discussed above with respect to FIGS. 1-2, the semantic image embedding and noise may be provided to a concatenator (e.g., concatenator 116, 216) and concatenated together using the concatenator to generate the concatenated embedding. The concatenated embedding generated by the concatenator may comprise a latent space representation that captures the semantic image embedding and the noise. For example, the concatenated embedding may comprise one or more vectors, a tensor, or another type of latent space representation of the semantic image embedding and the noise that is generated by the concatenator. The noise may be provided to the concatenator as another input in addition to the semantic image embedding. The noise may comprise, for example, random noise, white noise, or another type of noise. The noise may be generated by a noise generator or another component of a synthetic data generation system suitable for generating the noise.

The method 700, at block B708, includes generating an image from the concatenated embedding using one or more diffusion models. The concatenated embedding may be provided as input (e.g., conditioning) for the diffusion model(s) (e.g., diffusion model(s) 110) from the concatenator of the synthetic data generation system. The diffusion model(s) may include a forward diffusion process and a denoising network. As discussed above with respect to FIGS. 1-2, the forward diffusion process (e.g., forward diffusion process 112) of the diffusion model(s) may be used primarily during training, and the denoising network (e.g., denoising network 114) of the diffusion model(s) may comprise a U-Net based model (e.g., or other convolutional neural network (CNN) for image generation) or other type denoising network. The denoising network of the diffusion model(s) may iteratively remove noise from the concatenated embedding provided by the concatenator based on conditioning to generate a latent space representation of the image. The latent space representation of the image may comprise one or more vectors, a tensor, or another type of latent space representation of the image that is output by the denoising network. The latent space representation of the image may then be decoded to generate the image. For example, the latent space representati8on of the image may be provided by the denoising network to a decoder (e.g., decoder 118, 218) and decoded using that decoder. The decoder may comprise, for example, a variational autoencoder (VAE) decoder. The generated image may comprise a RGB image, CMYK image, monochrome image, IR image, or other type of image.

In some embodiments, the denoising network may be conditioned using the text embedding through one or more cross-attention mechanisms. As discussed above with respect to FIG. 1, textual information (e.g., textual information 106) may be received by the synthetic data generation system in addition to the semantic image. The textual information may comprise textual description of desired features of the image to be generated using the synthetic data generation system. The textual information may be provided by a user (e.g., via a user interface). The textual information may also be generated by one or more machine learning models (e.g., vision-language models). The received textual information may be compressed or encoded to generate the text embedding (e.g., text embedding 109). For example, as discussed above with respect to FIG. 1, the received textual information may be provided to an encoder (e.g., encoder 108) and compressed or encoded using the encoder to generate the text embedding. The text embedding may comprise a latent space representation of the textual information. For example, the text embedding may comprise one or more vectors, a tensor, or another type of latent space representation of the received textual information that is generated by the encoder. The encoder may comprise a Contrastive Language-Image Pre-Training (CLIP) encoder or other type of encoder suitable for generating the text embedding based on the textual information received as input.

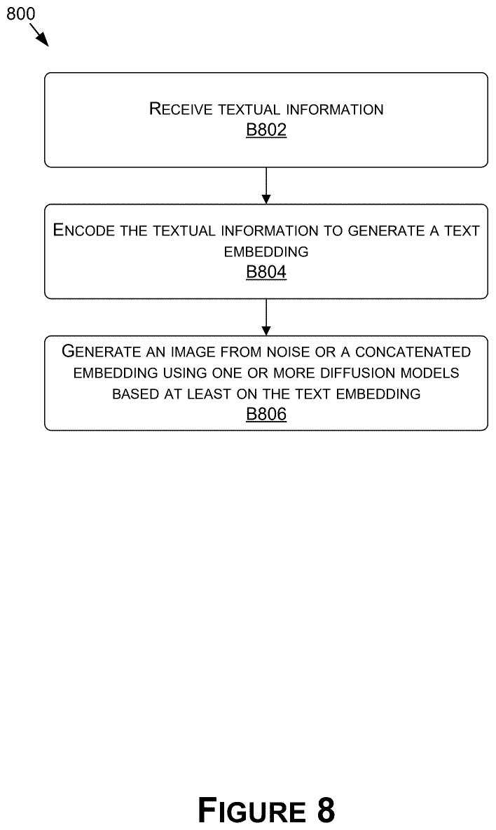

Now referring to FIG. 8, FIG. 8 is a flow diagram showing a method 800 for generating synthetic images, in accordance with some embodiments of the present disclosure. Each block of method 800, described herein, comprises a computing process that may be performed using any combination of hardware, firmware, and/or software. For instance, various functions may be carried out by a processor executing instructions stored in memory. The method may also be embodied as computer-usable instructions stored on computer storage media. The method may be provided by a standalone application, a service or hosted service (standalone or in combination with another hosted service), or a plug-in to another product, to name a few. In addition, method 800 is described, by way of example, with respect to the system of FIGS. 1 and 3. However, this method may additionally or alternatively be executed by any one system, or any combination of systems, including, but not limited to, those described herein.

The method 800, at block B802, includes receiving textual information. As discussed above with respect to FIGS. 1 and 3, the textual information (e.g., textual information 106, 306) may be received by the synthetic data generation system in addition to, or instead of, a semantic image. The textual information may comprise textual description of desired features of the synthetic data to be generated using the synthetic data generation system. For example, in the context of a warehouse, the textual information may include text prompt(s) or other description of the characteristics of the warehouse, stationary object(s) (e.g., shelves, boxes, pallets, etc.), and/or dynamic object(s) (e.g., forklifts, humans, robots, etc.) that are desired for the synthetic data. The textual information may be provided by a user (e.g., via a user interface). The textual information may also be generated by one or more machine learning models (e.g., vision-language models).

The method 800, at block B804, includes encoding the textual information to generate a text embedding. The received textual information may be compressed or encoded to generate the text embedding (e.g., text embedding 109). For example, as discussed above with respect to FIGS. 1 and 3, the received textual information may be provided to an encoder (e.g., encoder 108, 308) and compressed or encoded using the encoder to generate the text embedding. The text embedding may comprise a latent space representation of the textual information. For example, the text embedding may comprise one or more vectors, a tensor, or another type of latent space representation of the received textual information that is generated by the encoder. The encoder may comprise a Contrastive Language-Image Pre-Training (CLIP) encoder or other type of encoder suitable for generating the text embedding based on the textual information received as input.

The method 800, at block B806, includes generating an image from noise or a concatenated embedding using one or more diffusion models based at least on the text embedding. The text embedding may be provided as input (e.g., conditioning) for the diffusion model(s) (e.g., diffusion model(s) 110) from the encoder of the synthetic data generation system. The diffusion model(s) may include a forward diffusion process and a denoising network. As discussed above with respect to FIGS. 1 and 3, the forward diffusion process (e.g., forward diffusion process 112) of the diffusion model(s) may be used primarily during training, and the denoising network (e.g., denoising network 114) of the diffusion model(s) may comprise a U-Net based model (e.g., or other convolutional neural network (CNN) for image generation) or other type denoising network.

Where the textual information is received without a semantic image, the image is generated from noise using the diffusion model(s). The noise (e.g., noise 313) may be provided as input for the diffusion model(s). The noise may comprise, for example, random noise, white noise, or another type of noise. The noise may be generated by a noise generator or another component of a synthetic data generation system suitable for generating the noise. The denoising network of the diffusion model(s) may iteratively remove noise from the noise provided by the noise generator or other component of the synthetic data generation system, and the denoising network may be conditioned using the text embedding through one or more cross-attention mechanisms. The latent space representation of the image may comprise one or more vectors, a tensor, or another type of latent space representation of the image that is output by the denoising network. The latent space representation of the image may then be decoded to generate the image. For example, the latent space representati8on of the image may be provided by the denoising network to a decoder (e.g., decoder 318) and decoded using that decoder. The decoder may comprise, for example, a variational autoencoder (VAE) decoder. The generated image may comprise a RGB image, CMYK image, monochrome image, IR image, or other type of image.

Where the textual information is received with a semantic image, the image is generated from a concatenated embedding using the diffusion model(s). The concatenated image may be generated by concatenating a semantic image embedding (e.g., semantic image embedding 105) and noise (e.g., noise 113) using a concatenator (e.g., concatenator 116). The concatenated embedding generated by the concatenator may comprise a latent space representation that captures the semantic image embedding and the noise. For example, the concatenated embedding may comprise one or more vectors, a tensor, or another type of latent space representation of the semantic image embedding and the noise that is generated by the concatenator. The noise may be provided to the concatenator as another input in addition to the semantic image embedding. The noise may comprise, for example, random noise, white noise, or another type of noise. The noise may be generated by a noise generator or another component of a synthetic data generation system suitable for generating the noise.

The concatenated embedding may be provided as input for the diffusion model(s). The denoising network of the diffusion model(s) may iteratively remove noise from the concatenated embedding provided by the concatenator of the synthetic data generation system, and the denoising network may be conditioned using the text embedding through one or more cross-attention mechanisms. The latent space representation of the image may comprise one or more vectors, a tensor, or another type of latent space representation of the image that is output by the denoising network. The latent space representation of the image may then be decoded to generate the image. For example, the latent space representati8on of the image may be provided by the denoising network to a decoder (e.g., decoder 118) and decoded using that decoder. The decoder may comprise, for example, a variational autoencoder (VAE) decoder. The generated image may comprise a RGB image, CMYK image, monochrome image, IR image, or other type of image.

In some embodiments, the systems and methods described herein may be performed within, or in conjunction with, a simulation environment (e.g., NVIDIA's Isaac Sim) using simulated data (e.g., simulated sensor data of simulated sensors of a virtual or simulated machine). For example, simulated movement and/or sensor data may be used to perform operations (e.g., navigation, validation, etc.) associated with a virtual machine within the environment. These simulated operations may be used to test performance of the underlying algorithms, systems, and/or processes prior to deploying them in the real world. In some instances, the simulation may be used to generate synthetic training data - e.g., synthetic training images from within the simulation. The synthetic training data (in addition to or alternatively from real-world data) may then be processed to generate corresponding semantic image(s) and/or textual information, for example. In any example, such as where a simulation environment is used for testing, validation, training, etc., the simulation environment and/or associated training data may be rendered or otherwise generated using one or more light transport algorithms - such as ray-tracing and/or path-tracing algorithms. In some embodiments, the simulation environment and/or one or more objects, features, or components thereof may be generated or managed within a three-dimensional (3D) content collaboration platform (e.g., NVIDIA's Omniverse) for industrial digitalization, generative physical artificial intelligence (AI), and/or other use cases, applications, or services. For example, the content collaboration platform or system may include a system for using or developing universal scene descriptor (USD) (e.g., OpenUSD) data for managing objects, features, scenes, etc., within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications.

In some embodiments, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications - such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

In some embodiments, the systems and methods described herein may be implemented using deep-learning supercomputers and/or dedicated AI computers powered by one or more graphics processing units (GPUs). For example, the systems and methods described herein may be implemented using OVX system(s) and/or DGX system(s) developed by NVIDIA. The systems and methods described herein may be implemented using systems that include one or more central processing units (CPUs), one or more GPUs, one or more data processing units (DPUs), network interface card(s), system memory, networking components (e.g., switches and/or network interface cards), and/or computer-readable media.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as one or more large language models (LLMs), one or more vision language models (VLMs), multi-modal language models, (MMLMs), systems for performing light transport simulation, systems for performing collaborative content creation for 3D assets, systems implemented at least partially using cloud computing resources, and/or other types of systems.

### EXAMPLE COMPUTING DEVICE

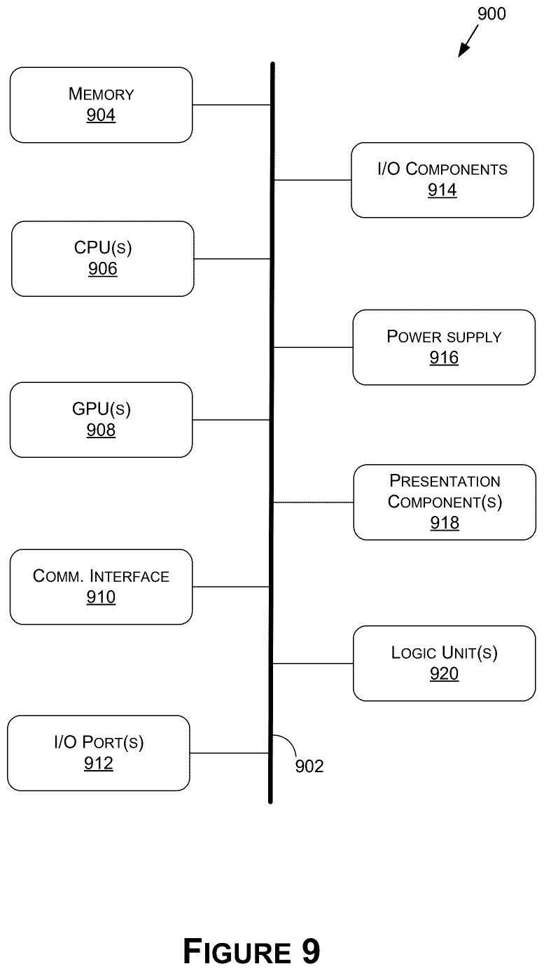

FIG. 9 is a block diagram of an example computing device(s) 900 suitable for use in implementing some embodiments of the present disclosure. In some embodiments, one or more functions of the synthetic data generation system 100, 200, 300 described herein may be performed using the computing device 900. Computing device 900 may include an interconnect system 902 that directly or indirectly couples the following devices: memory 904, one or more central processing units (CPUs) 906, one or more graphics processing units (GPUs) 908, a communication interface 910, input/output (I/O) ports 912, input/output components 914, a power supply 916, one or more presentation components 918 (e.g., display(s)), and one or more logic units 920. In at least one embodiment, the computing device(s) 900 may comprise one or more virtual machines (VMs), and/or any of the components thereof may comprise virtual components (e.g., virtual hardware components). For non-limiting examples, one or more of the GPUs 908 may comprise one or more vGPUs, one or more of the CPUs 906 may comprise one or more vCPUs, and/or one or more of the logic units 920 may comprise one or more virtual logic units. As such, a computing device(s) 900 may include discrete components (e.g., a full GPU dedicated to the computing device 900), virtual components (e.g., a portion of a GPU dedicated to the computing device 900), or a combination thereof.

Although the various blocks of FIG. 9 are shown as connected via the interconnect system 902 with lines, this is not intended to be limiting and is for clarity only. For example, in some embodiments, a presentation component 918, such as a display device, may be considered an I/O component 914 (e.g., if the display is a touch screen). As another example, the CPU(s) 906 and/or GPU(s) 908 may include memory (e.g., the memory 904 may be representative of a storage device in addition to the memory of the GPU(s) 908, the CPU(s) 906, and/or other components). As such, the computing device of FIG. 9 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 9.

The interconnect system 902 may represent one or more links or busses, such as an address bus, a data bus, a control bus, or a combination thereof. The interconnect system 902 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 906 may be directly connected to the memory 904. Further, the CPU 906 may be directly connected to the GPU 908. Where there is direct, or point-to-point connection between components, the interconnect system 902 may include a PCIe link to carry out the connection. In these examples, a PCI bus need not be included in the computing device 900.

The memory 904 may include any of a variety of computer-readable media. The computer-readable media may be any available media that may be accessed by the computing device 900. The computer-readable media may include both volatile and nonvolatile media, and removable and non-removable media. By way of example, and not limitation, the computer-readable media may comprise computer storage media and communication media.

The computer storage media may include both volatile and nonvolatile media and/or removable and non-removable media implemented in any method or technology for storage of information such as computer-readable instructions, data structures, program modules, and/or other data types. For example, the memory 904 may store computer-readable instructions (e.g., that represent a program(s) and/or a program element(s), such as an operating system. Computer storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 900. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 906 may be configured to execute at least some of the computer-readable instructions to control one or more components of the computing device 900 to perform one or more of the methods and/or processes described herein. The CPU(s) 906 may each include one or more cores (e.g., one, two, four, eight, twenty-eight, seventy-two, etc.) that are capable of handling a multitude of software threads simultaneously. The CPU(s) 906 may include any type of processor, and may include different types of processors depending on the type of computing device 900 implemented (e.g., processors with fewer cores for mobile devices and processors with more cores for servers). For example, depending on the type of computing device 900, the processor may be an Advanced RISC Machines (ARM) processor implemented using Reduced Instruction Set Computing (RISC) or an x86 processor implemented using Complex Instruction Set Computing (CISC). The computing device 900 may include one or more CPUs 906 in addition to one or more microprocessors or supplementary co-processors, such as math co-processors.

In addition to or alternatively from the CPU(s) 906, the GPU(s) 908 may be configured to execute at least some of the computer-readable instructions to control one or more components of the computing device 900 to perform one or more of the methods and/or processes described herein. One or more of the GPU(s) 908 may be an integrated GPU (e.g., with one or more of the CPU(s) 906 and/or one or more of the GPU(s) 908 may be a discrete GPU. In embodiments, one or more of the GPU(s) 908 may be a coprocessor of one or more of the CPU(s) 906. The GPU(s) 908 may be used by the computing device 900 to render graphics (e.g., 3D graphics) or perform general purpose computations. For example, the GPU(s) 908 may be used for General-Purpose computing on GPUs (GPGPU). The GPU(s) 908 may include hundreds or thousands of cores that are capable of handling hundreds or thousands of software threads simultaneously. The GPU(s) 908 may generate pixel data for output images in response to rendering commands (e.g., rendering commands from the CPU(s) 906 received via a host interface). The GPU(s) 908 may include graphics memory, such as display memory, for storing pixel data or any other suitable data, such as GPGPU data. The display memory may be included as part of the memory 904. The GPU(s) 908 may include two or more GPUs operating in parallel (e.g., via a link). The link may directly connect the GPUs (e.g., using NVLINK) or may connect the GPUs through a switch (e.g., using NVSwitch). When combined together, each GPU 908 may generate pixel data or GPGPU data for different portions of an output or for different outputs (e.g., a first GPU for a first image and a second GPU for a second image). Each GPU may include its own memory, or may share memory with other GPUs. In some embodiments, one or more functions of the synthetic data generation system 100, 200, 300 described herein may be executed, at least in part, by the CPU(s) 906 and/or GPU(s) 908.

In addition to or alternatively from the CPU(s) 906 and/or the GPU(s) 908, the logic unit(s) 920 may be configured to execute at least some of the computer-readable instructions to control one or more components of the computing device 900 to perform one or more of the methods and/or processes described herein. In embodiments, the CPU(s) 906, the GPU(s) 908, and/or the logic unit(s) 920 may discretely or jointly perform any combination of the methods, processes and/or portions thereof. One or more of the logic units 920 may be part of and/or integrated in one or more of the CPU(s) 906 and/or the GPU(s) 908 and/or one or more of the logic units 920 may be discrete components or otherwise external to the CPU(s) 906 and/or the GPU(s) 908. In embodiments, one or more of the logic units 920 may be a coprocessor of one or more of the CPU(s) 906 and/or one or more of the GPU(s) 908. In some embodiments, one or more functions of the synthetic data generation system 100, 200, 300 described herein may be executed, at least in part, by the logic unit(s) 920.

Examples of the logic unit(s) 920 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 910 may include one or more receivers, transmitters, and/or transceivers that allow the computing device 900 to communicate with other computing devices via an electronic communication network, included wired and/or wireless communications. The communication interface 910 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 920 and/or communication interface 910 may include one or more data processing units (DPUs) to transmit data received over a network and/or through interconnect system 902 directly to (e.g., a memory of) one or more GPU(s) 908.

The I/O ports 912 may allow the computing device 900 to be logically coupled to other devices including the I/O components 914, the presentation component(s) 918, and/or other components, some of which may be built in to (e.g., integrated in) the computing device 900. Illustrative I/O components 914 include a microphone, mouse, keyboard, joystick, game pad, game controller, satellite dish, scanner, printer, wireless device, etc. The I/O components 914 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 900. The computing device 900 may be include depth cameras, such as stereoscopic camera systems, infrared camera systems, RGB camera systems, touchscreen technology, and combinations of these, for gesture detection and recognition. Additionally, the computing device 900 may include accelerometers or gyroscopes (e.g., as part of an inertia measurement unit (IMU)) that allow detection of motion. In some examples, the output of the accelerometers or gyroscopes may be used by the computing device 900 to render immersive augmented reality or virtual reality.

The power supply 916 may include a hard-wired power supply, a battery power supply, or a combination thereof. The power supply 916 may provide power to the computing device 900 to allow the components of the computing device 900 to operate.

The presentation component(s) 918 may include a display (e.g., a monitor, a touch screen, a television screen, a heads-up-display (HUD), other display types, or a combination thereof), speakers, and/or other presentation components. The presentation component(s) 918 may receive data from other components (e.g., the GPU(s) 908, the CPU(s) 906, DPUs, etc.), and output the data (e.g., as an image, video, sound, etc.).

### EXAMPLE DATA CENTER

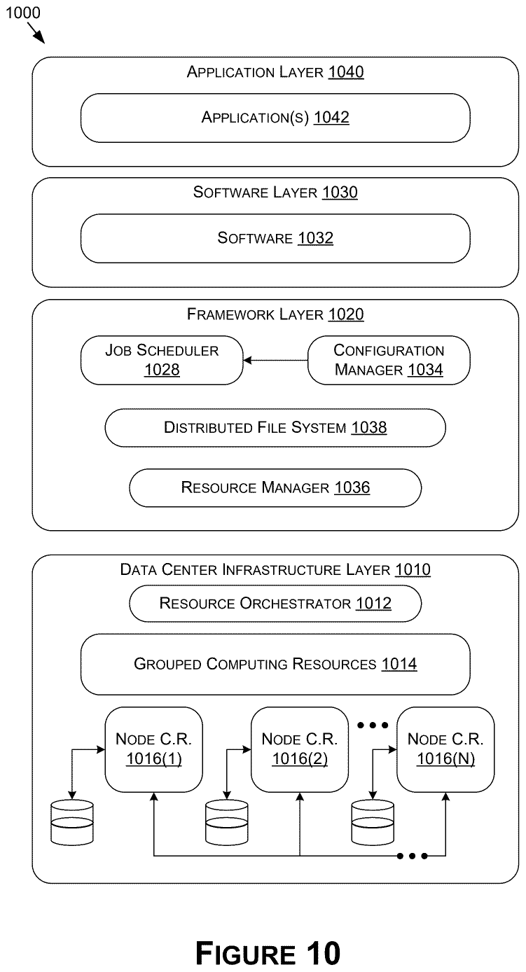

FIG. 10 illustrates an example data center 1000 that may be used in at least one embodiments of the present disclosure. The data center 1000 may include a data center infrastructure layer 1010, a framework layer 1020, a software layer 1030, and/or an application layer 1040.

As shown in FIG. 10, the data center infrastructure layer 1010 may include a resource orchestrator 1012, grouped computing resources 1014, and node computing resources (“node C.R.s”) 1016(1)-1016(N), where “N” represents any whole, positive integer. In at least one embodiment, node C.R.s 1016(1)-1016(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1016(1)-1016(N) may correspond to a server having one or more of the above-mentioned computing resources. In addition, in some embodiments, the node C.R.s 1016(1)-10161(N) may include one or more virtual components, such as vGPUs, vCPUs, and/or the like, and/or one or more of the node C.R.s 1016(1)-1016(N) may correspond to a virtual machine (VM). In some embodiments, one or more functions of the synthetic data generation system 100, 200, 300 described herein may be implemented, at least in part, using one or more of the node C.R.s 1016(1)-1016(N).

In at least one embodiment, grouped computing resources 1014 may include separate groupings of node C.R.s 1016 housed within one or more racks (not shown), or many racks housed in data centers at various geographical locations (also not shown). Separate groupings of node C.R.s 1016 within grouped computing resources 1014 may include grouped compute, network, memory or storage resources that may be configured or allocated to support one or more workloads. In at least one embodiment, several node C.R.s 1016 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1012 may configure or otherwise control one or more node C.R.s 1016(1)-1016(N) and/or grouped computing resources 1014. In at least one embodiment, resource orchestrator 1012 may include a software design infrastructure (SDI) management entity for the data center 1000. The resource orchestrator 1012 may include hardware, software, or some combination thereof.

In at least one embodiment, as shown in FIG. 10, framework layer 1020 may include a job scheduler 1028, a configuration manager 1034, a resource manager 1036, and/or a distributed file system 1038. The framework layer 1020 may include a framework to support software 1032 of software layer 1030 and/or one or more application(s) 1042 of application layer 1040. The software 1032 or application(s) 1042 may respectively include web-based service software or applications, such as those provided by Amazon Web Services, Google Cloud and Microsoft Azure. The framework layer 1020 may be, but is not limited to, a type of free and open-source software web application framework such as Apache Spark™ (hereinafter “Spark”) that may use distributed file system 1038 for large-scale data processing (e.g., “big data”). In at least one embodiment, job scheduler 1028 may include a Spark driver to facilitate scheduling of workloads supported by various layers of data center 1000. The configuration manager 1034 may be capable of configuring different layers such as software layer 1030 and framework layer 1020 including Spark and distributed file system 1038 for supporting large-scale data processing. The resource manager 1036 may be capable of managing clustered or grouped computing resources mapped to or allocated for support of distributed file system 1038 and job scheduler 1028. In at least one embodiment, clustered or grouped computing resources may include grouped computing resource 1014 at data center infrastructure layer 1010. The resource manager 1036 may coordinate with resource orchestrator 1012 to manage these mapped or allocated computing resources.

In at least one embodiment, software 1032 included in software layer 1030 may include software used by at least portions of node C.R.s 1016(1)-1016(N), grouped computing resources 1014, and/or distributed file system 1038 of framework layer 1020. One or more types of software may include, but are not limited to, Internet web page search software, e-mail virus scan software, database software, and streaming video content software.

In at least one embodiment, application(s) 1042 included in application layer 1040 may include one or more types of applications used by at least portions of node C.R.s 1016(1)-1016(N), grouped computing resources 1014, and/or distributed file system 1038 of framework layer 1020. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1034, resource manager 1036, and resource orchestrator 1012 may implement any number and type of self-modifying actions based on any amount and type of data acquired in any technically feasible fashion. Self-modifying actions may relieve a data center operator of data center 1000 from making possibly bad configuration decisions and possibly avoiding underutilized and/or poor performing portions of a data center.

The data center 1000 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1000. In at least one embodiment, trained or deployed machine learning models corresponding to one or more neural networks may be used to infer or predict information using resources described above with respect to the data center 1000 by using weight parameters calculated through one or more training techniques, such as but not limited to those described herein.

In at least one embodiment, the data center 1000 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1000, an example of which is described in more detail herein with respect to FIG. 10.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
receive a semantic image;
encode the semantic image to generate a semantic image embedding;
concatenate the semantic image embedding with noise to generate a concatenated embedding;
generate an image from the concatenated embedding using one or more diffusion models; and
update one or more parameters of one or more neural networks using the image and ground truth data corresponding to the image.

2. The one or more processors of claim 1, wherein the processing circuitry is further to receive textual information and encode the textual information to generate a text embedding; and
wherein the processing circuitry is to generate the image from the concatenated embedding using the one or more diffusion models based at least on the text embedding.

3. The one or more processors of claim 1, wherein the processing circuitry is to generate the image from the concatenated embedding using the one or more diffusion models by:
denoising the concatenated embedding to generate a latent space representation of the image; and
generating the image from the latent space representation.

4. The one or more processors of claim 1, wherein the semantic image depicts one or more first objects having a first semantic type using a first color and one or more second objects having a second semantic type using a second color different than the first color.

5. The one or more processors of claim 1, wherein the one or more diffusion models comprise a latent diffusion model.

6. The one or more processors of claim 1, wherein the processing circuitry is further to:
receive a second semantic image generated from the image using a semantic segmentation model;
encode the second semantic image to generate a second semantic image embedding;
concatenate the second semantic image embedding with noise to generate a second concatenated embedding; and
generate a second image from the second concatenated embedding using the one or more diffusion models.

7. The one or more processors of claim 1, wherein the processing circuitry is further to generate at least a portion of the semantic image based at least on user input.

8. The one or more processors of claim 1, wherein the one or more diffusion models are trained based at least on one or more RGB images, one or more semantic images, and textual information.

9. The one or more processors of claim 1, wherein the processing circuitry is further to:
receive textual information;
encode the textual information to generate a text embedding; and
generate a second image from noise using the one or more diffusion models based at least on the text embedding.

10. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-model language models (MMLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

11. A system comprising one or more processors to:
generate a text embedding based at least on encoding textual information; and
generate an image from noise using one or more diffusion models based at least on the text embedding, wherein the one or more diffusion models are trained based at least on data samples with corresponding ground truth images, semantic images, and textual information.

12. The system of claim 11, wherein the one or more processors are to condition a denoising network of the one or more diffusion models using the text embedding through one or more cross-attention mechanisms.

13. The system of claim 11, wherein the textual information is generated using one or more machine learning models.

14. The system of claim 11, wherein the one or more processors are further to:
receive a semantic image;
encode the semantic image to generate a semantic image embedding;
concatenate the semantic image embedding with noise to generate a concatenated embedding; and
generate a second image from the concatenated embedding using the one or more diffusion models.

15. The system of claim 14, wherein the semantic image depicts one or more first objects having a first semantic type using a first color and one or more second objects having a second semantic type using a second color different than the first color.

16. The one or more processors of claim 15, wherein the first semantic type corresponds to one or more stationary objects, wherein the second semantic type corresponds to one or more dynamic objects.

17. The system of claim 14, wherein the one or more processors are further to generate at least a portion of the semantic image using one or more semantic segmentation models.

18. The system of claim 11, wherein the one or more processors are further to:
receive second textual information;
generate a second text embedding by encoding the second textual information;
receive a semantic image;
encode the semantic image to generate a semantic image embedding;
concatenate the semantic image embedding with noise to generate a concatenated embedding; and
generate a second image from the concatenated embedding using the one or more diffusion models based at least on the second text embedding.

19. The system of claim 11, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-model language models (MMLMs);
a system for generating synthetic data;
a system for generating synthetic data using AI;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

20. A method comprising:
generating an image using one or more diffusion models based at least on a concatenated embedding, wherein the concatenated embedding comprises a semantic image embedding concatenated with noise.
